(19) United States
(12) Patent Application Publication
(10) Pub. No.: US 2011/0151340 A1
(43) Pub. Date: Jun. 23, 2011

(54) NON-AQUEOUS ELECTROLYTE CONTAINING AS A SOLVENT A BORATE ESTER AND/OR AN ALUMINATE ESTER

(75) Inventors: Nitin Kaskhedikar, Wolfsburg (DE); Joachim Maier, Wiernsheim (DE); Dieter Wiemhöfer, Munster (DE); Yunus Karatas, Kirsehir (TR)

(73) Assignees: Max-Planck-Gesellschaft zur Forderung der Wissenschaften E.V., Munchen (DE); Westfälische Wilhelms-Universität,Münster, Münster (DE)

(21) Appl. No.: 13/000,117

(22) PCT Filed: Jun. 19, 2009
(86) PCT No.: PCT/EP09/04440

§ 371 Date: Mar. 4, 2011

(30) Foreign Application Priority Data
Jun. 20, 2008 (EP) 08011249.3

(51) Int. Cl. H01M 6/14; H01G 9/022; H01M 6/16; H01G 9/155

(52) U.S. Cl. 429/339; 252/62.2; 429/188; 429/341; 429/199; 429/342; 361/502

(57) ABSTRACT

A non-aqueous electrolyte includes: at least one ionically conducting salt, a non-aqueous, anhydrous solvent for the ionically conductive salt, said solvent being selected to achieve a lithium transference number between 0.45 and 1.0, at least one oxide in a particulate form, said oxide being selected such that it is not soluble in said solvent and such that it is water-free.

The present invention relates to a non-aqueous electrolyte containing as a solvent a borate ester and/or an aluminate ester, which can e.g. be used in electrochemical devices, for example in a primary or secondary battery, such as a lithium battery, in a supercapacitor, in an electrochromic device or in a solar energy cell.

Lithium batteries are known in non-rechargeable and in rechargeable form. Such batteries comprise positive and negative electrodes with a non-aqueous electrolyte disposed between them.

In a rechargeable lithium ion battery (secondary battery) the positive electrode of the battery can for example be LiCoO₂ (referred to as the “cathode” in Li-battery community) and the negative electrode can for example be carbon (referred to as the “anode” in Li-battery community). In a non-rechargeable battery (primary battery) the positive electrode can for example be MnO₂ and the negative electrode can be lithium metal. Various different types of electrolyte are known. For example there is the class of liquid electrolytes comprising at least one ionically conducting salt, such as Li(TFSI), i.e. lithium bis(trifluorosulphonyl)imide, LiPF₆, i.e. lithium hexafluorophosphate, LiBOB (lithium bis(oxaltoborate) or LiClO4, i.e. lithium perchlorate, which are present, with a low degree of dissociation within a non-aqueous solvent, such as a mixture of DME (dimethylethane) and EC (ethylene carbonate), a mixture of DEC (diethylene carbonate) and EC, or a mixture of DMC (dimethyl carbonate) and EC or PC (propylene carbonate) or combinations thereof. A useful range for the degree of dissociation is the range from 1×10⁻¹ to 10⁸ 1⁻¹ mol⁻¹. In addition there are so-called dry polymer electrolytes. In these electrolytes the salt is selected as before (i.e. for example from Li(TFSI), LiPF₆, LiBOB or LiClO₄) and is dispersed in a polymer or mixture of polymers. Suitable polymers comprise PEO (polyethylene oxide), PVDF (polyvinylene di-fluoride), PAN (polyacrylonitrile), and PMMA (polymethyl methyl acrylate).

Furthermore, there are so called polymer gel electrolytes. These have the same basic composition as the dry polymer electrolytes recited above but include a solvent, for example a solvent of the kind recited in connection with the liquid electrolytes given above.

However, the present invention is not concerned with such polymer gel electrolytes, but instead provides a way of dispensing with polymers while nevertheless significantly improving the ionic transport.

In conventional electrolytes, the ion transport properties are dominated by anion transport, even though a higher lithium transport is desirable. The main reason for the higher anion transport in conventional electrolytes is that the solvation sphere of the lithium is larger than the anion solvation sphere, which makes the lithium ions less mobile.

The object underlying the present invention is therefore to provide an electrolyte, which, when applied in electrochemical devices such as those listed above, improves the performance of Li-based electrochemical devices, e.g. the electrochemical performance and the safety of the device.

According to the present invention this object is satisfied by providing a non-aqueous electrolyte including:
at least one ionically conducting salt,
at least one non-aqueous, anhydrous solvent for the ionically conductive salt, said solvent being selected to achieve a lithium trans-ference number of the electrolyte between 0.45 and 1.0,
at least one oxide in a discrete form, such as particles or nanowires or nanotubes, said oxide being selected such that it is not soluble in said solvent and such that it is water-free.

This solution is based on the surprising finding that by using a non-aqueous, anhydrous solvent for the ionically conductive salt achieving a lithium transference number between 0.45 and 1.0, the electrochemical properties in an electrochemical energy storage device, particularly in a rechargeable lithium battery, are significantly improved. While not wanting to be bound to a theory, it is considered that this improvement of the electrochemical properties is due to the fact that the aforementioned solvent enhances the cationic transport properties and limits the anionic transport between the anode and the cathode in the electrochemical energy storage device due to the interaction of the solvent with the anions of the ionically conducting salt. Furthermore, the oxide particles interact with the solvent to form stable/unstable networks as is explained later. Due to this, the ionic conductivity as well as the lithium transference number are increased.

The lithium transference number is measured according to the direct-current polarization method described by Bruce et al., “Conductivity and transference number measurements on polymer electrolytes”, Solid State Ionics (1988), pages 918 to 922 and by Mauro et al., “Direct determination of transference numbers of LiClO₄ solutions in propylene carbonate and acetonitrile”, Journal of Power Sources (2005), pages 167 to 170, both of which are incorporated herein by reference. The method disclosed by Mauro et al. is performed in a two-electrode non-blocking cell, in which two stainless steel current collectors are in close contact with two lithium metal discs sandwiched between a felt separator filled with the solution to be analyzed. A constant dc bias (which must be ≦0.03 V in order to obtain a linear response from the system) is applied to the electrodes of the cell and the current is measured. The current falls from an initial value i₀ to a steady-state value iₛ that is reached after 2 to 6 hours. With the passage of time, anions accumulate at the anode and are depleted at the cathode and a salt concentration gradient is formed. At the steady-state, the net anion flux falls to zero and only cations carry the current. Due to this, the cation transference number can be evaluated from the ratio iₛ/i₀. The value of iₛ (the steady-state current) is obtained from the end of the measured chronoamperometric curve. In order to determine the initial value i₀, about 1,000 points of the chronoamperometric curve recorded over the first second are analyzed assuming an exponential decay for the extrapolation to zero time. For this extrapolation, the least squares method to the experimental points using the following empirical equation is applied:

i(t)=i′+(i₀−i′)exp(−t/τ) (1),

where i′, τ and i₀ are variable parameters. In real cells, particularly in cells with active electrodes, the processes that occur at the surface are basically the charge transfer and the conduction through the dynamic passivating layer on the electrode, i.e. the intrinsic electrical resistance of the passive film. Since the thickness of the passivating film on the electrode will vary over the time required to reach a steady-state current, the values of the intrinsic resistance must be measured shortly before the application of the dc bias potential and immediately after the attainment of steady state in order to determine the correct cationic transference numbers t₊, by using the equation:

$${t}_{+} = \frac{{i}_{s} ( Δ V - {i}_{0} {R}_{0}^{′} )}{{i}_{0} ( Δ V - {i}_{s} {R}_{s}^{′} )} \qquad ( 2 )$$

In equation (2), the subscripts ₀ and ₛ indicate initial values and steady-state values respectively, R′ the sum of the charge transfer resistance R_{ct} and the passivating film resistance R_{film}, V the applied voltage, and i the current. The measurement of R′ₛ and R′₀ can be easily achieved by recording two impedance spectra on the cell in the frequency range between 0.1 Hz and 100 kHz before the application of the bias potential, and after the steady-state has been reached and the dc bias potential has been removed. The deconvolution of the spectra is made using the equivalent circuit where the processes of charge transfer and of conduction through the passivating layer are treated as two sub-circuits of a resistance and a constant phase element (CPE) in parallel (the CPE is more suitable than a pure capacitive element because of the fractal nature of the electrode-solution interface). The diameter of the obtained semicircle is approximately equal to the sum of R_{ct} and R_{film}, the exact value of which is obtained from the deconvolution of the spectrum. Growth of the passivating film on the lithium surface can be deduced from the measured increase of resistance.

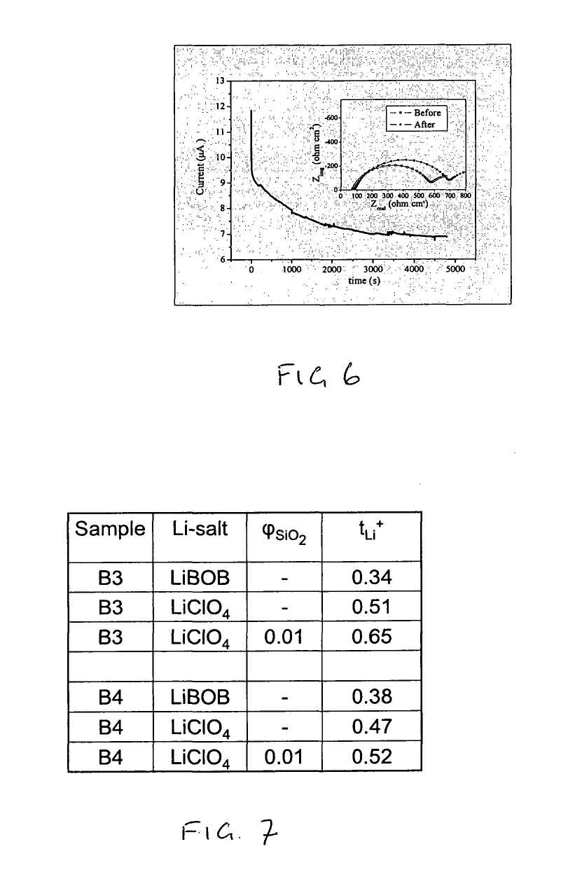

FIG. 6 illustrates how the transference number is determined. The inset shows the impedance measurement carried out before and after the application of the DC polarization voltage. In this example a peak value of about 11.9 μA is found for the initial current and a final value of about 6.7 μA is found for the steady state current resulting in a value for the lithium transference number of around 6.7/11.9=0.55. The table of FIG. 7 shows transference numbers for different electrolytes after correction for interfacial effects. The sample B3 (second entry in the table) yielded the curve of FIG. 6 with the corrected value changing from the value of 0.55 calculated above to 0.51. The second entry relates to the electrolytes comprising the lithium salt LiClO₄ in borate ester with n=2 as a solvent but without added oxide. The third entry shows how the lithium transference number increase dramatically to 0.65 on the addition of a volume fraction of 0.01 of SiO₂ of 10 nm particle size.

The entries for B4 relate to borate ester with n=3.

According to a preferred embodiment of the present invention, the solvent is selected to achieve a lithium transference number between 0.5 and 0.75 and more preferably between 0.5 and 0.65.

The electrolyte in accordance with the present teaching also makes devices incorporating the electrolyte much safer. The reasons are that the vapor pressure of the electrolyte is relatively low in comparison to conventional electrolytes and they also have a relatively high flash point.

Basically, any solvent can be used which is able to achieve a lithium transference number between 0.45 and 1.0. Particular good results are obtained, if the at least one solvent is a compound according to the general formula (I):

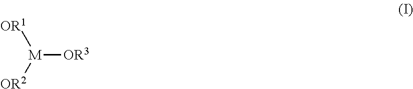

or a mixture of compounds of this kind
wherein:
M is selected from the group consisting of boron and aluminum, and R¹, R² and R³, independently from each other, are selected from the group consisting of alkyl, alkenyl, alkinyl, aryl, aralkyl, alkoxy, alkenyloxy, cycloalkyl, cycloalkenyl, cycloalkoxy, cycloalkenyloxy, aroxy, aralkoxy, alkylaroxy, cyanoalkyl, cyanoalkenyl, cyanoalkoxy, hydroxyalkyl, hydroxyalkenyl, hydroxylalkinyl, hydroxyaryl, hydroxyaralkyl, hydroxyalkoxy, hydroxyalkenyloxy, hydroxycycloalkyl, hydroxycycloalkenyl, hydroxycycloalkoxy, hydroxycycloalkenyloxy, hydroxyaroxy, hydroxyaralkoxy, hydroxyalkylaroxy, hydroxycyanoalkyl, hydroxycyanoalkenyl, hydroxycyanoalkoxy, halogenated alkyl, halogenated alkenyl, halogenated alkinyl, halogenated aryl, halogenated aralkyl, halogenated alkoxy, halogenated alkenyloxy, halogenated cycloalkyl, halogenated cycloalkenyl, halogenated cycloalkoxy, halogenated cycloalkenyloxy, halogenated aroxy, halogenated aralkoxy, halogenated alkylaroxy, halogenated cyanoalkyl, halogenated cyanoalkenyl, halogenated cyanoalkoxy, halogenated hydroxyalkyl, halogenated hydroxyalkenyl, halogenated hydroxylalkinyl, halogenated hydroxyaryl, halogenated hydroxyaralkyl, halogenated hydroxyalkoxy, halogenated hydroxyalkenyloxy, halogenated hydroxycycloalkyl, halogenated hydroxycycloalkenyl, halogenated hydroxycycloalkoxy, halogenated hydroxycycloalkenyloxy, halogenated hydroxyaroxy, halogenated hydroxyaralkoxy, halogenated hydroxyalkylaroxy, halogenated hydroxycyanoalkyl, halogenated hydroxycyanoalkenyl, halogenated hydroxycyanoalkoxy residues, ether group containing residues, thiol group containing residues, silicon containing residues, amide group containing residues and ester group containing residues.

Thus, it is also possible to use mixtures containing two or more different compounds falling under the general formula (I) as solvent, such as for example a mixture of a borate ester and an aluminate ester

Preferably, in the general formula (I), at least one of R¹, R² and R³ is an ether group containing residue according to the general formula (II):

—(R⁴O)ₙ—R⁵—R⁶ (II),

wherein:
R⁴ is an acyclic or cyclic alkyl group, an acyclic or cyclic halogenated alkyl group or an aryl group,
n is an integer between 0 and 100, preferably between 0 and 20, more preferably between 1 and 10 and most preferably of 1,
R⁵ is an acyclic or cyclic alkyl group, an acyclic or cyclic halogenated alkyl group or an aryl group, and
R⁶ is H, OH, CN, SH, a hydrocarbon group or a substituted hydrocarbon group, in particular an alkoxy group.

Particular good results are obtained, if in the general formula (II),
R4 is a linear C₁-C₁₀-alkyl group, preferably a C₁-C₆-alkyl group, more preferably a methyl, ethyl, propyl or butyl group,
n is an integer between 0 and 100, preferably between 0 and 20, more preferably between 1 and 10 and most preferably of 1,
R5 a linear C₁-C₁₀-alkyl group, preferably a C₁-C₆-alkyl group, more preferably a methyl, ethyl, propyl or butyl group, and

R6 is H, OH, CN, SH or a C₁-C₁₀-alkoxy group, preferably a methoxy, ethoxy, propoxy or butoxy group.

According to a further preferred embodiment of the present invention, in the general formula (I), at least one of R¹, R² and R³ is an ether group containing residue according to the general formula (III):

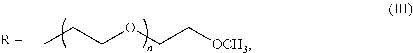

wherein n is an integer between 0 and 100, preferably between 0 and 20, more preferably between 1 and 10 and most preferably of 1, i.e. a compound according to the general formula (I), in which at least one of R¹, R² and R³ is a group according to the general formula (II), wherein R⁴ is an ethyl group, R⁵ is an ethyl group and R⁶ is a methoxy group.

As mentioned before, the residues R¹, R² and R³ in the general formula (I) can be selected independently from each other, i.e. all three residues may be different, two residues may be identical, while one is different or all three residues may be identical. Best results are achieved, if all three residues are identical, i.e. in the case that R¹═R²═R³.

Basically, in the non-aqueous electrolyte according to the present invention, any ionically conducting salt may be used as salt, which is known for an electrolyte. Merely by way of example, the at least one ionically conducting salt may be a lithium salt, a sodium salt, a magnesium salt or a silver salt. Preferred examples for the at least one ionically conducting salt are lithium salts, in particular lithium salts selected from the group consisting of LiCl, LiF, LiSO₃CF₃, LiClO₄, LiN(SO₂CF₃)₂, lithium-bis[oxalato]borate (LiBOB), LiPF₆ and LiN(SO₂CF₂CF₃)₂.

Preferably, the at least one ionically conducting salt is dissolved in the solvent in a concentration between 0.01 and 10 M, more preferably in a concentration between 0.5 and 1.5 M and most preferably in a concentration of about 1 M.

The non-aqueous electrolyte according to the present invention may contain—in addition to the aforementioned anhydrous solvent—a second non-aqueous solvent. The second non-aqueous solvent could, for example, be selected from the group consisting of ethylene carbonate, dimethyl carbonate, diethyl carbonate, propylene carbonate, poly(ethylene glycols), ionic liquids such as imidazolium bis-(trifluoro methane sulphonyl)imide and any mixtures thereof.

The non-aqueous electrolyte according to the present invention is not limited to any particular material for the at least one oxide as long as this is not soluble in the solvent and as long as it is water-free. Suitable oxides include those which are selected from the group comprising oxides exhibiting acidic properties, preferably SiO₂, fumed SiO₂, TiO₂, and oxides exhibiting basic properties, preferably Al₂O₃, MgO, mesoporous oxides, clays and any mixtures thereof.

Fumed silica is, for example, available from the company Evonic Degussa and preferably has average dimensions (length, width and height) in the nanometer scale, e.g. 5 nm to 100 nm.

According to a preferred embodiment of the present invention, the at least one oxide is present in the electrolyte in an amount by volume in the range from 0.005 to 0.2%, preferably in the range from 0.005 to 0.1% and more preferably in the range from 0.005 to 0.05%. The specific optimum actually depends on the particle size, the lithium salt and the solvent or solvent mixtures, especially on the viscosity of the solvent or solvent mixture. In particular, the oxide particles may be contained in a low volume fraction between 0.005 and 0.05, in a medium volume fraction between 0.05 and 0.075 or in a high volume fraction of more than 0.075.

Particularly good results are achieved, when the average particle size of the at least one oxide in a particulate form is between 5 nm and 300 μm. More preferably, the average particle size of the at least one oxide lies between 5 nm and 100 μm and even more preferably between 5 nm and 50 nm.

The non-aqueous electrolyte of the present invention is not restricted to the use in a battery, but it can for example be used in a supercapacitor, in electrochromic devices, such as electrochromic displays, or in a solar energy cell.

Thus, a further subject matter of the present patent application is a battery comprising positive and negative electrodes and the aforementioned non-aqueous electrolyte.

According to a further aspect of the present patent application, there is provided a supercapacitor comprising positive and negative electrodes and the aforementioned non-aqueous electrolyte.

A further subject matter of the present patent application is an electrochromic device including the aforementioned non-aqueous electrolyte.

According to a further aspect of the present patent application, there is provided a solar energy cell including the aforementioned electrolyte.

Subsequently, the present invention is further described by means of four non limiting examples and with reference to the accompanying drawings which show:

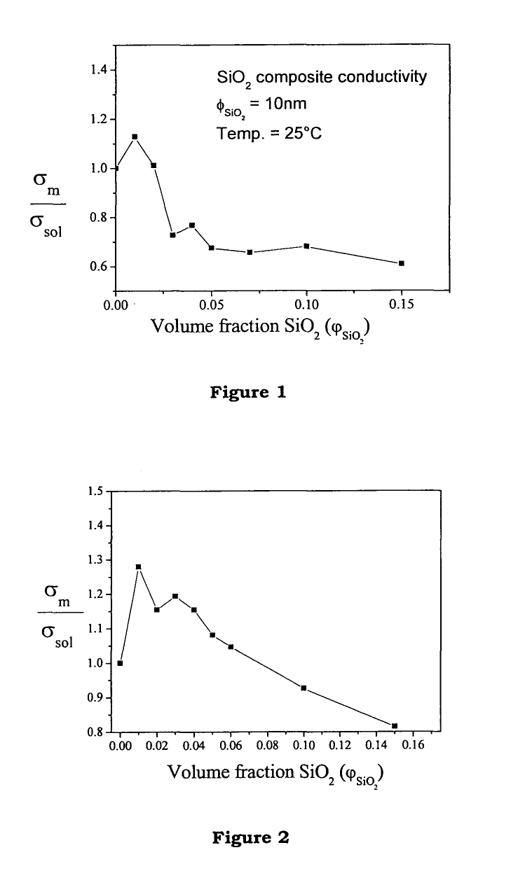

FIG. 1 a graph illustrating the variation of the composite conductivity as a function of the volume fraction of SiO₂ particles of 10 nm size using LiBOB as a lithium salt and borate ester with n=2 as a solvent.

FIG. 2 a graph similar to FIG. 1 but with LiClO₄ as a lithium salt instead of LiBOB,

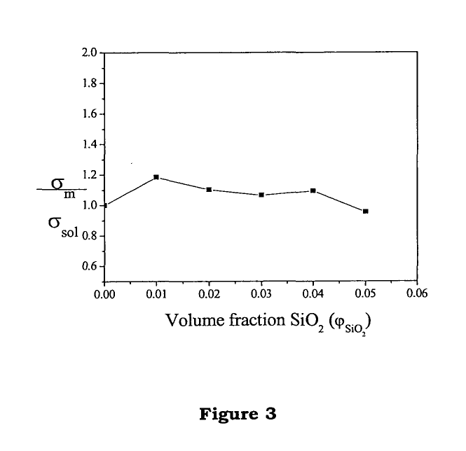

FIG. 3 a graph similar to FIG. 2 but with SiO₂ particles of 7 nm size instead of 10 nm size,

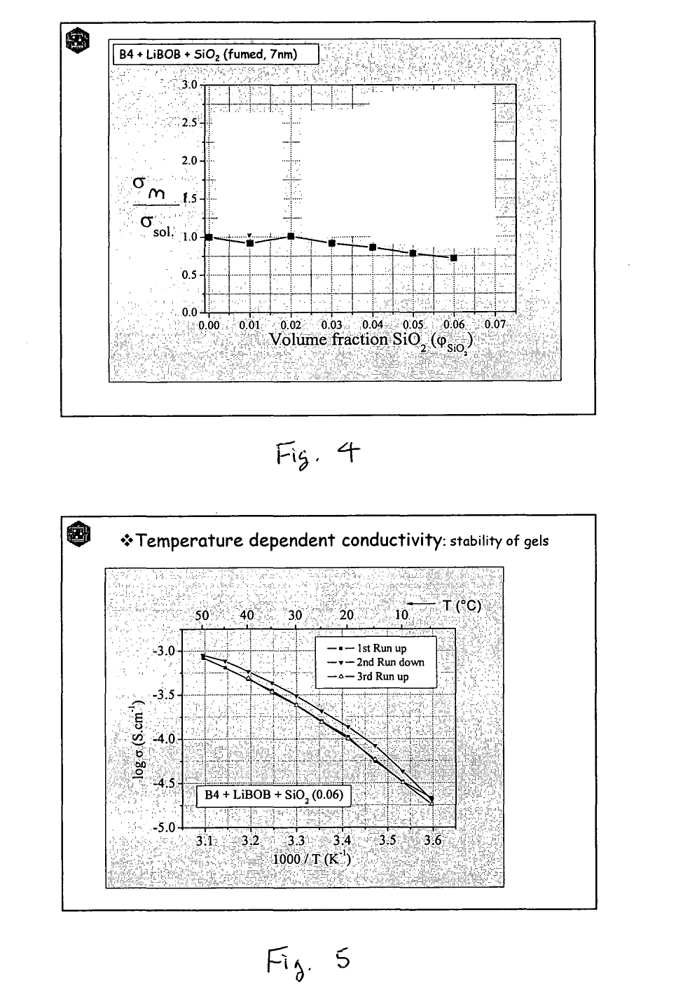

FIG. 4 a graph similar to FIG. 3 but with LiBOB instead of LiClO₄ and with borate ester with n=3 as a solvent,

FIG. 5 a graph showing the temperature dependent conductivity and stability of the composition of FIG. 4 but with a volume fraction of SiO₂ of 0.06,

FIG. 6 illustrates the measurement of the lithium transference number in this case for LiClO₄ as lithium salt and borate ester with n=2 as a solvent, and

FIG. 7 a table showing lithium transference numbers for various compositions in accordance with the invention.

### EXAMPLE 1

A non-aqueous electrolyte according to the present invention was prepared which included as solvent a borate ester according to the following formula (IV):

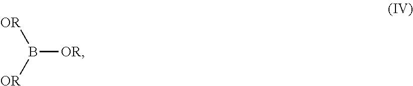

wherein B represents boron and the residues R were represented by the following formula (V):

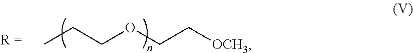

wherein n was 2.

A lithium salt in the form of LiBOB was dissolved in this solvent in a concentration of 1 mol/kg, before different amounts of SiO₂ particles having a particle size of about 10 nm were added.

Finally, the conductivities of all resulting electrolytes were measured at room temperature. The results are shown in FIG. 1 in form of a diagram of the composite conductivity ratio σₘ/σₛₒₗ versus the SiO₂ volume fraction, wherein σₘ denotes the conductivity of the electrolyte comprising the lithium salt and the solvent with oxides and σₛₒₗ denotes the conductivity of the electrolyte comprising the lithium salt and the solvent but without oxides.

Although it might be thought from FIG. 1 that an addition of 0% of the oxide might still lead to a good value of 1.0 for the composite conductivity, this is not actually the case because the equation σₘ/σₛₒₗ degenerates to σₛₒₗ/σₛₒₗ and the conductivity is actually low. Thus, a minimum volume fraction of oxide of about 0.005% is required.

### EXAMPLE 2

The experiment of Example 1 was repeated with n=3 and fumed SiO₂ with a particle size of 7 nm. The result is similar to that shown in FIG. 3 as discussed in connection with example 4.

### EXAMPLE 3

The experiment described in example 1 was repeated except that 1 mol/kg LiClO₄ was used as an ionically conductive salt instead of LiBOB.

The conductivities of the resulting electrolytes were measured at room temperature. The results are shown in FIG. 2 in form of a diagram of the composite conductivity ratio σₘ/σₛₒₗ versus the SiO₂ volume fraction wherein, as before, σₘ denotes the conductivity of the composite with oxides and σₛₒₗ denotes the conductivity of the composite without oxides.

### EXAMPLE 4

The experiment described in example 3 as repeated except that SiO₂ particles having a particle size of about 7 nm were used instead of SiO₂ particles having a particle size of about 10 nm.

The conductivities of all resulting electrolytes were measured at room temperature. The results are shown in FIG. 3 in form of a diagram of the composite conductivity ratio σₘ/σₛₒₗ versus the SiO₂ volume fraction wherein, as before, σₘ denotes the conductivity of the composite with oxides and σₛₒₗ denotes the conductivity of the composite without oxides.

Another interesting advantage will now be explained with reference to FIGS. 1 to 3. It can be seen that the graph of FIG. 1 has a pronounced peak at a volume fraction of SiO₂ of about 0.01%. In this case the SiO₂ particles have a size of 10 nm.

By simply changing the particle size to 7 nm, the graph of FIG. 3 arises which has a much flatter shape with almost constant composite conductivity. In FIG. 3 the composition with 0.05 vol. % of SiO₂ is essentially a gel or a dimensionally stable solid and is particularly advantageous because the danger of leakage is very significantly reduced in comparison to compositions with a lower volume fraction of SiO₂ which are essentially liquid.

FIG. 4 shows the equivalent situation to FIG. 2, but again using SiO₂ particles of 7 nm size. Again the curve is substantially flattened and again the electrolyte is a dimensionally stable solid once the volume fraction of SiO₂ reaches 0.05. Technically the situation shown in FIGS. 3 and 4 at volume fractions of SiO₂ above 0.05 is referred to as a stable network, whereas lower fractions are regarded as unstable networks.

Moreover, as shown in FIG. 5, the dimensionally stable shape of the electrolyte is present over a large temperature range, i.e. from sub-zero temperatures to above 50° C.

FIG. 5 shows that this stability is preserved during thermal cycling between 5 and 50° C. It should be noted that although much of the specific discussion has hitherto related to particle sizes of around 10 nm, large particle sizes for the oxide up to at least 300 μm can be used to advantage if the oxides are in mesoporous form.

Also, although much of the discussion has related to lithium, the invention is equally applicable to elements such as sodium, silver or magnesium. In the case of other elements, a transference number can be measured in just the way as described here for lithium and the same range of transference numbers have been measured or are expected.

It seems that the added oxide material ensures that the lithium salt (or other metal salt) is more completely split into the corresponding ions which favor ionic transport of the metal ions.

Also it should be noted that the electrolyte of the present invention can be used in a battery or other device without any separator because the electrolyte can have the form of a dimensionally stable thin film.

1-18. (canceled)

19. A non-aqueous electrolyte including:
at least one ionically conducting salt,
at least one non-aqueous, anhydrous solvent for the ionically conductive salt, said electrolyte having a lithium transference number between 0.5 and 1.0, and at least one oxide in a discrete particulate form having particle sizes in the range from 5 nm to 50 nm and comprising an oxide selected from the group of oxides exhibiting acidic properties, SiO₂, TiO₂, oxides exhibiting basic properties, Al₂O₃, MgO, mesoporous oxides, clays and any mixtures thereof, said oxide being present in the electrolyte in an amount by volume in the range from 0.005 to 0.2%, said oxide being selected such that it is not soluble in said solvent and such that it is water-free.

20. A non-aqueous electrolyte in accordance with claim 19, wherein said lithium transference number is between 0.5 and 0.75 and more preferably between 0.5 and 0.65.

21. A non-aqueous electrolyte in accordance with claim 19, wherein said at least one solvent is a compound according to the general formula (I): 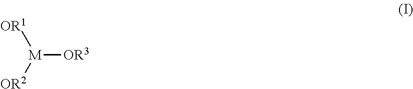
or a mixture of compounds of this kind
wherein:
M is selected from the group consisting of boron and aluminum, and
R¹, R² and R³, independently from each other, are selected from the group consisting of alkyl, alkenyl, alkinyl, aryl, aralkyl, alkoxy, alkenyloxy, cycloalkyl, cycloalkenyl, cycloalkoxy, cycloalkenyloxy, aroxy, aralkoxy, alkylaroxy, cyanoalkyl, cyanoalkenyl, cyanoalkoxy, hydroxyalkyl, hydroxyalkenyl, hydroxylalkinyl, hydroxyaryl, hydroxyaralkyl, hydroxyalkoxy, hydroxyalkenyloxy, hydroxycycloalkyl, hydroxycycloalkenyl, hydroxycycloalkoxy, hydroxycycloalkenyloxy, hydroxyaroxy, hydroxyaralkoxy, hydroxyalkylaroxy, hydroxycyanoalkyl, hydroxycyanoalkenyl, hydroxycyanoalkoxy, halogenated alkyl, halogenated alkenyl, halogenated alkinyl, halogenated aryl, halogenated aralkyl, halogenated alkoxy, halogenated alkenyloxy, halogenated cycloalkyl, halogenated cycloalkenyl, halogenated cycloalkoxy, halogenated cycloalkenyloxy, halogenated aroxy, halogenated aralkoxy, halogenated alkylaroxy, halogenated cyanoalkyl, halogenated cyanoalkenyl, halogenated cyanoalkoxy, halogenated hydroxyalkyl, halogenated hydroxyalkenyl, halogenated hydroxylalkinyl, halogenated hydroxyaryl, halogenated hydroxyaralkyl, halogenated hydroxyalkoxy, halogenated hydroxyalkenyloxy, halogenated hydroxycycloalkyl, halogenated hydroxycycloalkenyl, halogenated hydroxycycloalkoxy, halogenated hydroxycycloalkenyloxy, halogenated hydroxyaroxy, halogenated hydroxyaralkoxy, halogenated hydroxyalkylaroxy, halogenated hydroxycyanoalkyl, halogenated hydroxycyanoalkenyl, halogenated hydroxycyanoalkoxy residues, ether group containing residues, thiol group containing residues, silicon containing residues, amide group containing residues and ester group containing residues.

22. A non-aqueous electrolyte in accordance with claim 21, wherein, in the general formula (I), at least one of R¹, R² and R³ is an ether group containing residue according to the general formula (II):
—(R⁴O)ₙ—R⁵—R⁶ (II),
wherein:
R⁴ is one of an acyclic alkyl group, a cyclic alkyl group, an acyclic halogenated alkyl group, a cyclic halogenated alkyl group and an aryl group,
n is an integer between 0 and 100,
R⁵ is one of an acyclic alkyl group, a cyclic alkyl group, an acyclic halogenated alkyl group, a cyclic halogenated alkyl group and an aryl group, and
R⁶ is any one of H, OH, CN, SH, a hydrocarbon group a substituted hydrocarbon group, and an alkoxy group.

23. A non-aqueous electrolyte in accordance with claim 22 wherein n, is selected in the range 0 to 20.

24. A non-aqueous electrolyte in accordance with claim 22 wherein n, is selected in the range between 1 and 10

25. A non-aqueous electrolyte in accordance with claim 22 wherein n, is selected to be 1.

26. A non-aqueous electrolyte in accordance with claim 22, wherein, in the general formula (II),
R⁴ is any one of a linear C₁-C₁₀-alkyl group, a C₁-C₆-alkyl group, a methyl group, an ethyl group, a propyl group and a butyl group,
n is an integer between 0 and 100,
R⁵ a any one of a linear C₁-C₁₀-alkyl group, a C₁-C₆-alkyl group, a methyl group, an ethyl group, a propyl group and a butyl group, and
R⁶ is any one of H, OH, CN, SH, a C₁-C₁₀-alkoxy group, a methoxy group, an ethoxy group, a propoxy group and a butoxy group.

27. A non-aqueous electrolyte in accordance with claim 26, wherein, in the general formula (I), at least one of R¹, R² and R³ is an ether group containing residue according to the general formula (III): 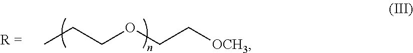
wherein n is an integer between 0 and 100,

28. A non-aqueous electrolyte in accordance with claim 27 wherein n, is selected in the range 0 to 20.

29. A non-aqueous electrolyte in accordance with claim 27 wherein n, is selected in the range between 1 and 10

30. A non-aqueous electrolyte in accordance with claim 27 wherein n, is selected to be 1.

31. A non-aqueous electrolyte in accordance with claim 21, wherein R¹═R²═R³.

32. A non-aqueous electrolyte in accordance with claim 19, wherein said at least one ionically conducting salt is one of a lithium salt, a sodium salt, a magnesium salt and a silver salt.

33. A non-aqueous electrolyte in accordance with claim 32, wherein said at least one ionically conducting salt is a lithium salt selected from the group consisting of LiCl, LiF, LiSO₃CF₃, LiClO₄, LiN(SO₂CF₃)₂, lithium-bis[oxalato]borate (LiBOB), LiPF₆ and LiN(SO₂CF₂CF₃)₂.

34. A non-aqueous electrolyte in accordance with claim 19, wherein the at least one ionically conducting salt is dissolved in the solvent in a concentration between 0.01 and 10 M.

35. A non-aqueous electrolyte in accordance with claim 19, wherein the at least one ionically conducting salt is dissolved in the solvent in a concentration between 0.5 and 1.5 M.

36. A non-aqueous electrolyte in accordance with claim 19, wherein the at least one ionically conducting salt is dissolved in the solvent in a concentration of about 1 M.

37. A non-aqueous electrolyte in accordance with claim 19, wherein said non-aqueous electrolyte further contains at least one additional non-aqueous solvent selected from the group consisting of ethylene carbonate, dimethyl carbonate, diethyl carbonate, propylene carbonate, poly(ethylene glycols), ionic liquids such as imidazolium bis-(trifluoro methane sulphonyl)imide and any mixtures thereof.

38. A non-aqueous electrolyte in accordance with claim 19, wherein said at least one oxide is selected from the group comprising oxides exhibiting acidic properties, SiO₂, fumed SiO₂, TiO₂, and oxides exhibiting basic properties, Al₂O₃, MgO, mesoporous oxides, clays and any mixtures thereof.

39. A non-aqueous electrolyte in accordance with claim 19, wherein said at least one oxide is present in the electrolyte in an amount by volume in the range from 0.005 to 0.2%.

40. A non-aqueous electrolyte in accordance with claim 19, wherein said at least one oxide is present in the electrolyte in an amount by volume in the range from 0.005 to 0.1%.

41. A non-aqueous electrolyte in accordance with claim 19, wherein said at least one oxide is present in the electrolyte in an amount by volume of 0.05% 0.24.

42. A non-aqueous electrolyte in accordance with claim 19, wherein the average particle size of the at least one oxide in a particulate form is between 5 nm and 300 μm.

43. A non-aqueous electrolyte in accordance with claim 19, wherein the average particle size of the at least one oxide in a particulate form is between 5 nm and 100 μm.

44. A non-aqueous electrolyte in accordance with claim 19, wherein the average particle size of the at least one oxide in a particulate form is between 5 and 50 nm.

45. A battery comprising positive and negative electrodes and a non-aqueous electrolyte in accordance with claim 19.

46. A supercapacitor comprising positive and negative electrodes and a non-aqueous electrolyte in accordance with claim 19.

47. An electrochromic device including an electrolyte in accordance with claim 19.

48. A solar energy cell including an electrolyte in accordance with claim 19.
